(19) United States
(12) Patent Application Publication
(10) Pub. No.: US 2008/0305276 A1
(43) Pub. Date: Dec. 11, 2008

(54) Method of Applying Hot Gas Anticorrosion Layers

(75) Inventors: Erwin Bayer, Dachau (DE); Joerg Hoeschele, Meckenbeuren (DE); Albin Platz, Ried-Baindlkirch (DE); Stefan Schneiderbanger, Lauterbach (DE); Juergen Steinwandel, Uhldingen-Muehlhofen (DE)

Correspondence Address: CROWELL & MORING LLP;INTELLECTUAL PROPERTY GROUP, P.O. BOX 14300, WASHINGTON, DC, 20044-4300, US

(73) Assignee: MTU AERO ENGINES GMBH, MUNICH (DE)

(21) Appl. No.: 11/596,404

(22) PCT Filed: May 20, 2005
(86) PCT No.: PCT/DE2005/001041

§ 371 Date: Jul. 29, 2008

(30) Foreign Application Priority Data
May 21, 2004 (DE) 10 2004 025 139.8

(51) Int. Cl. B05D 5/00

(52) U.S. Cl. 427/576; 427/252

(57) ABSTRACT

A method for applying hot gas anticorrosion layers to high-temperature-resistant alloys, either nickel-based or cobalt-based alloys, in the form of a gradient layer consisting of one or more elements of the platinum group in combination with aluminum. The components are introduced into a directional high-temperature, high-enthalpy, free jet of solid, liquid or gaseous precursors in mixing ratios such that defined concentration gradients can be established in the layer.

### BACKGROUND AND SUMMARY OF THE INVENTION

This application claims the priority of International Application No. PCT/DE2005/001041, filed May 20, 2005, and German Patent Document No. 10 2004 025 139.8, filed May 21, 2004, the disclosures of which are expressly incorporated by reference herein.

The invention relates to a method of applying hot gas anticorrosion layers to a material with a Ni-based or Co-based material.

In aircraft gas turbines, hot gas corrosion protection in the high temperature range is required in the area of the high pressure turbine, in particular the blades and vane segments. To do so, the components, which are made of a Ni-based material (in special cases also a Co-based material) are coated with a noble metal from the platinum group, preferably platinum itself.

Then the respective component is diffusion-annealed at a temperature of approx. 1000° C. The resulting composite material is then aluminized by a thermochemical process. Aluminizing creates a PtAl gradient material which forms Al₂O₃ at the surface during operation, thus providing a protective layer against corrosive gases (e.g., nitrogen oxides, sulfur oxides). This protective layer is initially consumed by the corrosive/erosive attack. However, due to boundary diffusion of aluminum present in the material in combination with the free oxygen in the turbine gas, new Al₂O₃ is constantly being formed again, and thus an appropriate protective effect is maintained. When the Al present in the material is consumed due to the constant boundary diffusion, a corresponding component (blade, vane segment) must be aluminized again for reuse.

Traditional methods of producing the hot gas anticorrosion layers are galvanic or chemical methods, for example. These two method variants are characterized in that the layer is applied at least in a primary step from the liquid phase. One disadvantage of these methods is that not all combinations of materials can be produced. In addition, these methods are comparatively cost intensive due to the great amount of time/labor involved.

The object of the invention is to provide a correspondingly economical method with which hot gas anticorrosion layers may be applied to a Ni-based or Co-based material.

According to the invention, metallic precursors are introduced into a directional high-temperature, high-enthalpy jet to produce the hot gas anticorrosion layers; a metal vapor is generated from the metallic precursors and deposited on a component to form a gradient layer.

First an adhesive layer of an identical material or at least a related material is advantageously applied to the base material of the hot gas components, which are blades and vane segments, for example, and are usually made of high-temperature-resistant nickel alloys (but also Co alloys). According to the invention, this is also accomplished by a coating method characterized by a directional high-temperature, high-enthalpy flow. A plasma flow, primarily of a thermal nature (thermodynamic equilibrium plasma flow, characterized by either a full or local thermodynamic equilibrium, FTE, LTE) may advantageously be used here. Corresponding plasma flows can be produced by expanding high-current arc discharges (working range of the arc voltages preferably greater than 100 V, working range of the arc currents preferably greater than 500 Å) using argon/hydrogen primary gases.

Alternatively, high-enthalpy flows of the required power range may be produced by high frequency-induced plasmas (e.g., by inductive coupling of electromagnetic radiation in the frequency range of 0.8 MHz to 10 MHz).

In such high temperature high-enthalpy flows, a powdered material of the Ni-based or Co-based material or a similar material may be vaporized or fragmented on a nanoscale to produce an adhesive layer. This following expansion of the metal vapor bound to the carrier gas leads to a directional free jet and to deposition of a fine crystalline layer. The entire relevant component is coated.

An alternative method of applying the adhesive layer utilizing the specific properties of high-temperature, high-enthalpy flows consists of introducing gaseous precursors (e.g., sublimed halides from the corresponding salt compounds, practical examples of which include NiCl₂, Al₂Cl₆, CoCl₂, PtCl₄, PdCl₂) or direct precursor gases (e.g., Al(CH)₃, Ni(CO)₄) and liquid precursors (e.g., H₂PtCl₆) into the flows and reducing them to metal atoms and/or metallic nanoparticles (metal clusters) by means of proportional hydrogen in the process gas.

The result of this process variant is likewise a metal vapor bound to a carrier gas in accordance with the previous variant of metal powders.

Following this, the actual hot gas anticorrosion layer is applied in gradient form with different concentrations of the required constituents by an identical method.

### BRIEF DESCRIPTION OF THE DRAWING

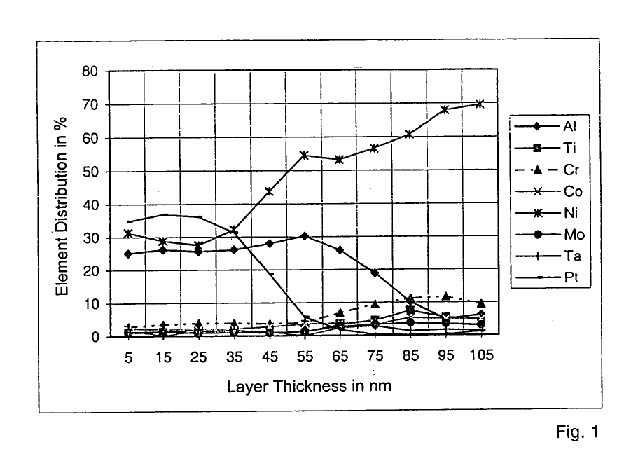

A specific exemplary embodiment is illustrated in FIG. 1, which shows the element composition of one of these special hot gas anticorrosion layers.

### DETAILED DESCRIPTION OF THE EXEMPLARY EMBODIMENT

The specific layer of FIG. 1 is a possible exemplary embodiment. Different gradients and/or other components can be produced by a similar method according to the invention.

It is advantageous that the mixing ratios and/or gradients which may be implemented in virtually any form may be adapted to the specific corrosion conditions. These depend on the particular temperature of the component and the specific pressure, the amount of corrosive gases resulting from the fuel composition and the individual combustion chamber parameters (average and local flame temperatures, average and local oxygen levels).

It is also advantageous that the desired layer composition can be adjusted by means of the inventive method in a one-step process management.

1-4. (canceled)

5. A method for applying hot gas anticorrosion layers to a Ni-based or Co-based material, wherein metallic precursors are introduced into a directional high-temperature, high-enthalpy jet, and a metal vapor is generated from the metallic precursors and deposited on a component to form a gradient layer.

6. The method according to claim 5, wherein the precursors are a mixture of solid, liquid or gaseous precursors having pre-selectable concentration ratios.

7. The method according to claim 5, wherein elements of a platinum group in combination with aluminum are present in the layer.

8. The method according to claim 5, wherein a thickness of the gradient layer is between 30 and 150 μm.

9. A method of applying a hot gas anticorrosion layer to a component, comprising the steps of:
introducing a metallic precursor into a directional high-temperature, high-enthalpy flow;
generating a metal vapor from the metallic precursor; and
depositing the metal vapor on the component to form a gradient layer.

10. The method according to claim 9, wherein the component includes a Ni-based or Co-based material.

11. The method according to claim 9, wherein the flow is a plasma flow.

12. The method according to claim 11, wherein the plasma flow is produced by expanding high-current arc discharges.

13. The method according to claim 11, wherein the plasma flow is produced by a high frequency induced plasma.

14. The method according to claim 9, further comprising the step of applying an adhesive layer to the component prior to the step of forming the gradient layer.

15. The method according to claim 14, wherein the adhesive layer is applied by a plasma flow.

16. The method according to claim 15, wherein the plasma flow includes a powdered material.

17. The method according to claim 15, wherein the plasma flow includes a gaseous precursor, a direct precursor gas, or a liquid precursor.

18. The method according to claim 9, further comprising the step of adjusting a composition of the gradient layer.

19. A method of applying an anticorrosion layer to a component, comprising the steps of:
generating a metal vapor from a plasma flow; and
depositing the metal vapor on the component to form the anticorrosion layer.

20. The method according to claim 19, wherein the step of generating the metal vapor from the plasma flow includes the step of introducing a metallic precursor into the plasma flow.

21. The method according to claim 19, wherein the component includes a Ni-based or Co-based material.

22. The method according to claim 21, wherein the component is a component of a gas turbine engine.

23. The method according to claim 19, further comprising the step of applying an adhesive layer to the component prior to the step of forming the anticorrosion layer.

24. The method according to claim 23, wherein the adhesive layer is applied by a plasma flow.
